(19) United States
(12) Patent Application Publication
(10) Pub. No.: US 2015/0114331 A1
(43) Pub. Date: Apr. 30, 2015

(54) METHOD FOR CONTROLLING A CORONA IGNITION DEVICE AND CORONA IGNITION DEVICE

(71) Applicant: BorgWarner Ludwigsburg GmbH, Ludwigsburg (DE)

(72) Inventors: Markus Kernwein, Bretten (DE); Torsten Schremmer, Ludwigsburg (DE); Thomas Holzschuh, Roth (DE)

(21) Appl. No.: 14/515,961

(22) Filed: Oct. 16, 2014

(30) Foreign Application Priority Data
Oct. 25, 2013 (DE) 10 2013 111 806.2

(51) Int. Cl. H01T 19/00; F02P 23/04

(52) U.S. Cl. CPC H01T 19/00; F02P 23/04
USPC 123/143 B; 361/263

(57) ABSTRACT

A method for controlling a corona ignition device, which comprises an ignition electrode, at which a corona discharge is produced, a resonating circuit, which contains the ignition electrode, and a high-frequency generator connected to the resonating circuit, wherein the resonating circuit is excited with an AC voltage (Uᵢ) produced by the high-frequency generator, the frequency of said voltage being specified by a control signal (U_{d}) applied across the high-frequency generator, the frequency of the control signal (U_{d}) is changed as the control variable of a control circuit, and the phase position between the current (Iᵢ) flowing in the resonating circuit and a voltage signal is regulated to a target value, characterised in that the target value is changed during the operation of the corona ignition device. A corona ignition device for igniting fuel in a combustion chamber of an internal combustion engine is also described.

### RELATED APPLICATIONS

This application claims priority to DE 10 2013 111 806.2, filed Oct. 25, 2013, which is hereby incorporated herein by reference in its entirety.

### BACKGROUND

The invention relates to a method for controlling a corona ignition device of the type having an ignition electrode at which a corona discharge is produced, a resonating circuit which contains the ignition electrode, and a high frequency generator connected to the resonating circuit. Such corona ignition devices of this general description are known from, e.g., U.S. Publication No. 2011/0114071 A1.

US 2011/0114071 A1 discloses a corona ignition system with which a fuel/air mixture in a combustion chamber of an internal combustion engine can be ignited by a corona discharge produced in the combustion chamber. This corona ignition system has an ignition electrode, which protrudes from an insulator. The ignition electrode, the insulator and a sleeve surrounding the insulator form an electrical capacitor. This capacitor is part of an electrical resonating circuit of the corona ignition device, which resonating circuit is excited with a high-frequency AC voltage for example from 30 kHz to 50 MHz. This thus results in a voltage excess at the ignition electrode so that a corona discharge forms at said electrode.

For efficient operation, it is important that the excitation frequency of the resonating circuit is as close as possible to the resonance frequency thereof.

US 2011/0114071 A1 teaches to control the frequency of the resonating circuit by measuring the phase shift between current and voltage at the feed points of the resonating circuit and regulating the phase shift to the value zero by means of a phase control loop. In a resonating circuit, current and voltage are in phase (phase shift=zero) in the case of resonance. The phase control loop controls the switching frequency of a switching device, with which a predefined voltage is applied alternately to one primary winding and to the other primary winding of the transformer, such that current and voltage are in phase with one another on the secondary side of the transformer, that is to say at the feed points of the resonating circuit.

In prior art, the shift of the resonance frequency of the HF resonating circuit, which contains the igniter, is a significant problem. There are various reasons for this. One cause of the shift of the resonance frequency is constituted by changes in temperature, moisture, a contamination of the tip or tips of the ignition electrode of the igniter and also by changes of parameters associated with the operation of the internal combustion engine. An adjustment of the excitation frequency to the resonance frequency by means of a phase control loop, as disclosed in US 2011/0114071 A1, is complex, however, and only solves the problem in part. The phase control is specifically susceptible to a temperature drift of the components of the phase control loop and to voltage noise.

In order to avoid the disadvantages of a phase control loop, it is known from DE 10 2011 052 096 A1 to monitor the present values of current or voltage of the resonating circuit and to excite the high-frequency generator with primary voltage pulses, which are started or ended when the present value of current or voltage falls below or exceeds a predefined switching threshold. This method has the disadvantage of being very complex in terms of the measurement technology.

### SUMMARY

This disclosure teaches a method of operating a corona ignition device in the vicinity of the resonance frequency thereof with relatively low effort.

In the case of conventional corona ignition devices with a phase control loop, the phase position between the current flowing in the resonating circuit and the voltage produced by the high-frequency generator is controlled to zero. Within the scope of this disclosure, it has been found that such a phase position generally is not optimal. The resonating circuit of a corona ignition device contains significant parasitic capacitances and inductances. The imaginary part of the impedance of the resonating circuit is therefore at the feed point, that is to say at the end of a power line leading from the high-frequency generator to the oscillating circuit, unequal to zero in the case of resonance. In order to excite the oscillating circuit optimally, a defined phase shift is therefore necessary.

If the resonating circuit is connected via a cable to the HF generator, there is a mismatch between the wave impedance of the cable and the resonating circuit which changes depending on the electrical power of the resonating circuit. This power-dependent maladjustment has to be compensated for by an additional phase shift in order to feed the power provided by the high-frequency generator efficiently into the resonating circuit. In addition, parasitic capacitances of the resonating circuit are temperature-dependent, and therefore the optimal phase position changes with the operating temperature of the engine.

On the whole, the above-mentioned effects mean that the optimal phase position is dependent on engine operating parameters, in particular the temperature and electrical power of the corona ignition device. In accordance with this disclosure, the target value of the phase position is therefore changed during running operation, for example depending on the electrical power of the resonating circuit. In the case of a typical corona ignition device, the target value of the phase position may change in a range of which the upper and lower limits differ by 30°, depending on the operating state of the engine.

The target value of the phase position can be determined for example by means of a table or characteristic curves that have been created for a given corona ignition device.

In an advantageous refinement of this disclosure, the phase position between a control signal of the high-frequency generator and the current flowing in the resonating circuit is controlled to a target value. The detection of the voltage in the resonating circuit, for example the zero crossings, is complex in terms of the measurement technology, whereas the control signal is known exactly and is available without complex measurement.

The AC voltage in the resonating circuit follows the control signal with a constant phase offset. The magnitude of this offset is dependent on the switching and response times of the components of the high-frequency generator and can thus be defined for a given corona ignition device. The magnitude of this phase offset has a constant value for a given corona ignition device. When the phase offset between the control signal and the current flowing in the resonating circuit has precisely this value, the resonating circuit is excited with the resonance frequency thereof. In this case, current and voltage of the resonating circuit are specifically in phase, such that the phase offset between the control signal and the current of the resonating circuit is the same as the phase offset between the control signal and the voltage of the resonating circuit.

Since the phase offset between the control signal and the current flowing in the resonating circuit is controlled to a target value, the resonating circuit can therefore be excited with the resonance frequency thereof.

With a method according to this disclosure for controlling a corona ignition device, the frequency of the control signal is then thus the control variable of a control circuit with which the phase offset between the control signal and the current flowing in the resonating circuit is controlled to a target value.

Since the control signal of the high-frequency generator is used for phase control, a considerable improvement, specifically a more cost-effective manufacture, can be attained even with a control to a constant target value. One aspect of this disclosure therefore concerns a method for controlling a corona ignition device, which comprises an ignition electrode, at which a corona discharge is produced, a resonating circuit, which contains the ignition electrode, and a high-frequency generator connected to the resonating circuit, wherein the resonating circuit is excited with an AC voltage produced by the high-frequency generator, the frequency of said voltage being predefined by a control signal applied across the high-frequency generator, and the frequency of the control signal as the control variable of a control circuit is changed, characterised in that, in the control circuit, the phase position between the current flowing in the resonating circuit and the control signal is measured and is controlled to a target value.

A control circuit is formed by a controller and a controlled system. In the present case, the system contains the high-frequency generator and the resonating circuit of the corona ignition device, that is to say it delivers the physical variable to be controlled, specifically the phase offset between the control signal and the current flowing in the resonating circuit. The term “control circuit” is thus used in the present application in accordance with the conventional meaning thereof.

The controller used in accordance with this disclosure may be a proportional controller, for example. The proportional controller may be a pure proportional controller without integral and differential parts (P controller) or a proportional controller with integral and differential parts (PID controller, PI controller, PD controller). However, the controller may also be a simpler controller, for example a controller that always responds to a deviation of the phase offset between the control signal and the current flowing in the oscillating circuit from the target value with a change of the frequency of the control signal by a constant value. The frequency of the control signal is thus increased or reduced by a constant value depending on the direction in which the phase offset between the control signal and the current flowing in the resonating circuit deviates from the target value.

The phase position between the control signal and the current flowing in the resonating circuit can be measured in various ways. A simple possibility lies in monitoring the current and producing a pulsed square wave signal, of which the duty cycle is linearly dependent on the phase position between the control signal and the current flowing in the resonating circuit. The duration of the pulse of such a square wave signal or the duration of the pauses between the pulses can then be compared with a target value.

By way of example, the pulsed square wave signal can be produced by starting a square pulse with each rising zero crossing of the current and by ending a square pulse with each rising zero crossing of the control signal. The square wave signal can just as well be produced by ending a square pulse with each rising zero crossing of the current and by starting a square pulse with each rising zero crossing of the control signal.

Instead of rising zero crossings, a change can also be triggered by falling zero crossings, that is to say for example the square wave signal can be produced by starting a square pulse with each falling zero crossing of the current and by ending a square pulse with each falling zero crossing of the control signal. The square wave signal can just as well be produced by ending a square pulse with each falling zero crossing of the current and by starting a square pulse with each falling zero crossing of the control signal.

Here, the zero crossing of a signal is understood to mean the passage through the middle value between maximum and minimum. In the case of a sine-like course of the current flowing in the resonating circuit, the zero crossings are thus identical with the zero points of the sine function. When the control signal is a square wave signal, the zero crossings thereof lie in the rising and falling flanks thereof.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a schematic illustration of an example of a corona ignition device;

FIG. 2 shows a further schematic illustration of the corona ignition device;

FIG. 3 shows an example for the course over time of the control signal U_{d}, of the voltage in the resonating circuit Uᵢ, of the current Iᵢ flowing in the resonating circuit and of the phase signal in the case of a resonantly excited resonating circuit;

FIG. 4 shows an illustration according to FIG. 3 for the case that the excitation frequency of the resonating circuit is smaller than the resonance frequency thereof;

FIG. 5 shows an illustration according to FIG. 3 for the case that the excitation frequency of the resonating circuit is greater than the resonance frequency thereof.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

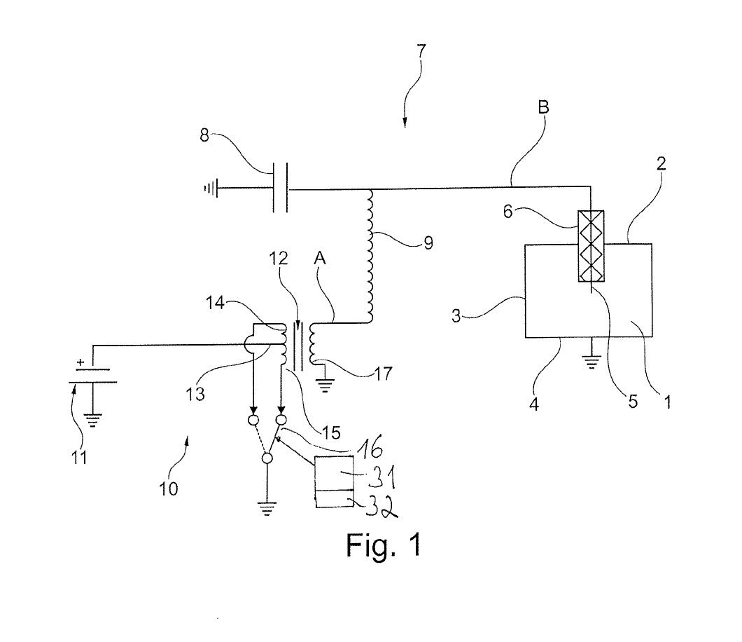

FIG. 1 shows a combustion chamber 1, which is delimited by walls 2, 3 and 4, which are at ground potential. An ignition electrode 5 protrudes into the combustion chamber 1 from above and is surrounded over part of the length thereof by an insulator 6, by means of which the ignition electrode is guided through the upper wall 2 into the combustion chamber 1 in an electrically insulated manner. The ignition electrode 5 and the walls 2 to 4 of the combustion chamber 1 are part of a series resonating circuit 7, to which a capacitor 8 and an inductor 9 also belong. Of course, the series resonating circuit 7 may comprise further inductors and/or capacitors and other components known to a person skilled in the art as possible parts of series resonating circuits.

The resonating circuit 7 is excited by a high-frequency generator 10, which has, on the primary side thereof, a DC voltage source 11 and a transformer 12 with a centre tap 13. Two primary windings 14 and 15 meet at the centre tap 13. By means of a high-frequency changeover switch 16, the ends of the primary windings 14 and 15 remote from the centre tap 13 are connected alternately to ground. The switching frequency of the high-frequency changeover switch 16 determines the frequency at which the series resonating circuit 7 is excited, and is variable. The secondary winding 17 of the transformer 12 feeds the series resonating circuit 7 at point A. The high-frequency changeover switch 16 is controlled by a control unit 31. The control unit 31 thus specifies the frequency of the AC voltage which is produced by the high-frequency generator as secondary voltage and with which the resonating circuit 7 is excited.

Such a resonating circuit 7 with an ignition electrode 5 is provided for each combustion chamber of an engine. A high-frequency generator 10 may supply a number of resonating circuits 7. However, it is also possible for each resonating circuit to be connected to a dedicated high-frequency generator 10. In both cases a single control unit 31 is sufficient.

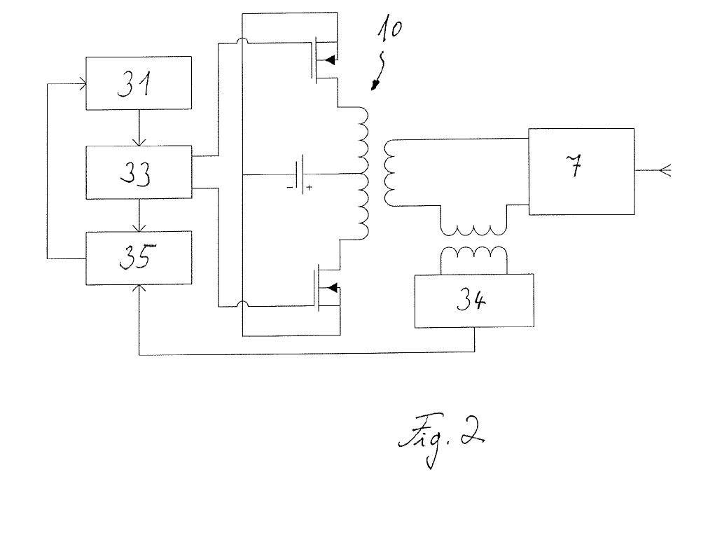

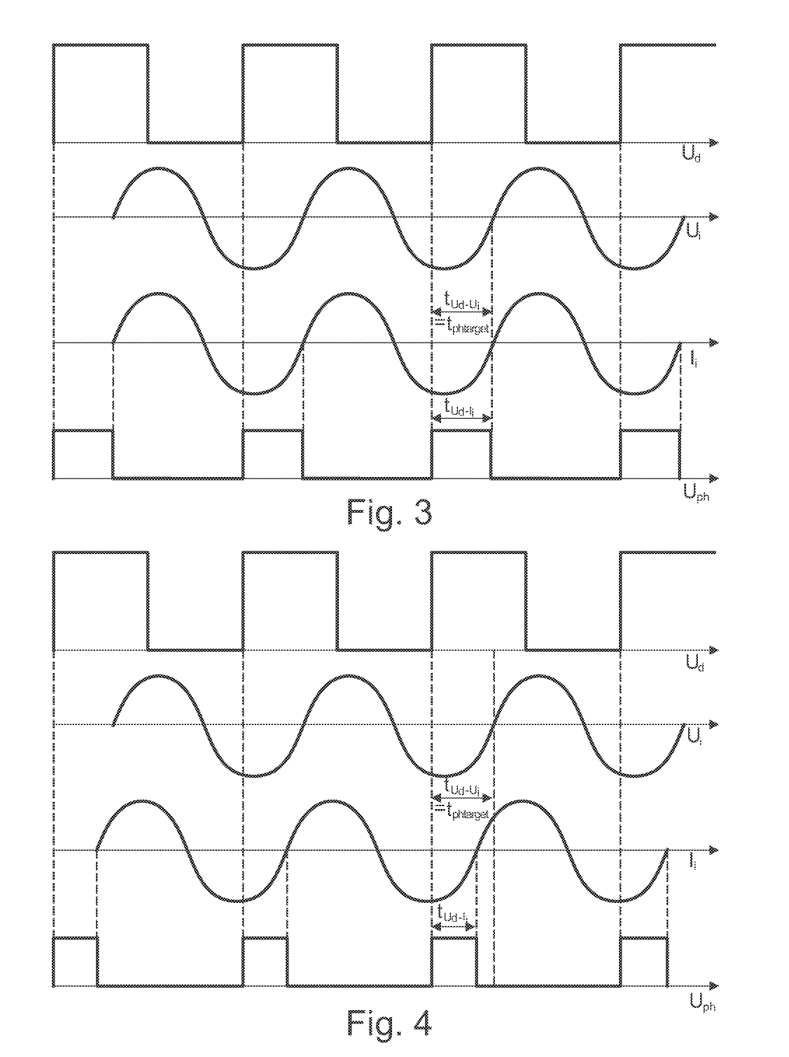

FIG. 2 schematically shows the high-frequency generator 10 with the resonating circuit 7 connected thereto and components of the control unit 31, for example a processor. The control unit 31 controls the high-frequency generator 10 via a driver 33 with which the control unit 31 produces a control signal U_{d}, which specifies the frequency of the AC voltage Uᵢ produced by the high-frequency generator 10 and is shown schematically in FIGS. 3 to 5. In the shown illustrative embodiment, the control signal determines the switching frequency of the high-frequency changeover switch 16, which is illustrated in FIG. 2 in the form of two field-effect transistors.

The current Iᵢ flowing in the resonating circuit is monitored using a measuring transformer and a connected sensor 34. The sensor 34 may be a switch, for example, which responds to a zero crossing of the current Iᵢ. Similarly to the control signal, the signal produced by the sensor 34 is supplied to a signal processing unit 35, which may be part of the control unit 31, but is illustrated in FIG. 2 as a separate component for clarity.

The control signal is a symmetrical square wave signal. Both rising and falling flanks of this square wave signal cause a changeover operation of the high-frequency changeover switch 16. The voltage Uᵢ in the resonating circuit 7 and the control signal U_{d} have the same frequency and are phase-shifted relative to one another by a constant angle Φ, which is generally different from zero.

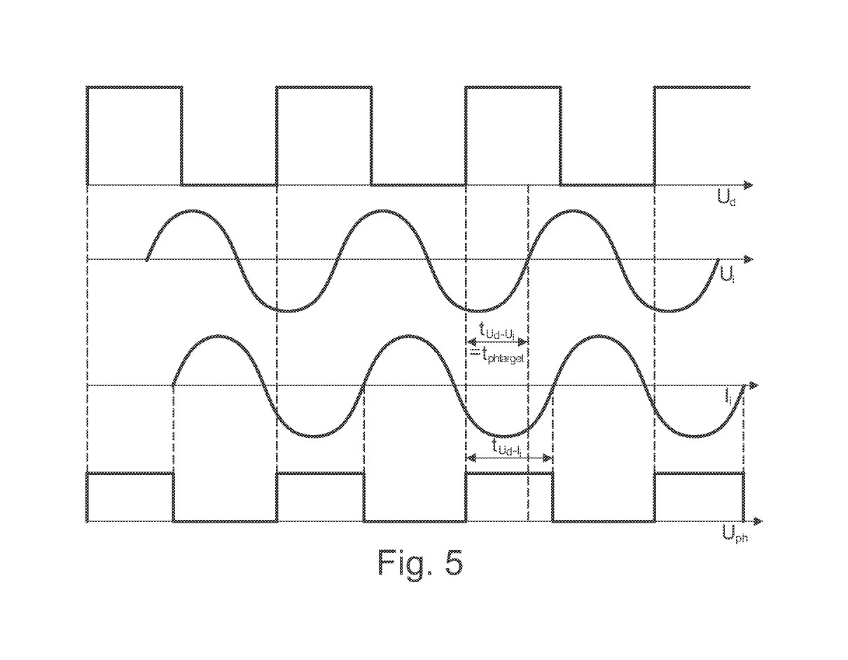

In FIG. 3 the course of the voltage Uᵢ and of the current Iᵢ in the resonating circuit 7 are illustrated schematically for the case that the frequency of the voltage Uᵢ matches the resonance frequency of the resonating circuit 7. The voltage Uᵢ and current Iᵢ are in phase in this case. FIG. 4 schematically shows the course of the voltage Uᵢ and of the current Iᵢ in the resonating circuit 7 for the case that the frequency of the voltage Uᵢ is less than the resonance frequency of the resonating circuit 7. FIG. 5 schematically shows the course of the voltage Uᵢ and of the current Iᵢ in the resonating circuit 7 for the case that the frequency of the voltage Uᵢ is greater than the resonance frequency of the resonating circuit 7.

The control unit 31 controls the phase offset between the control signal U_{d} and the current Iᵢ flowing in the resonating circuit 7 to a target value, at which the resonating circuit 7 is resonantly excited. This target value is the phase offset by the angle Φ, which occurs between the voltage Uᵢ in the resonating circuit 7 and the control signal U_{d}. This phase offset by the angle Φ corresponds to a time t, which passes between a rising zero crossing of the control signal U_{d} and a rising zero crossing of the voltage Uᵢ. This time is indicated in FIGS. 3 to 5 by t_{phtarget} and typically lies between 0 and 200 ns.

In order to control the phase position, the control unit 31 produces a phase signal Uₚₕ, which is illustrated in FIGS. 3 to 5. The phase signal Uₚₕ is a square wave signal, which is set in each shown example when a rising flank of the control signal U_{d} occurs. In other words, a voltage pulse of the phase signal Uₚₕ always then starts when a voltage pulse of the control signal U_{d} starts. The phase signal Uₚₕ is reset in each shown example when a rising zero crossing of the current Iᵢ flowing in the resonating circuit 7 occurs. The voltage pulses of the phase signal Uₚₕ are ended with a rising zero crossing of the current Iᵢ flowing in the resonating circuit 7. The length of the voltage pulses of the phase signal Uₚₕ thus corresponds to the phase offset between the voltage Uᵢ in the resonating circuit 7 and the control signal U_{d}.

The control unit 31 controls the length of the voltage pulses of the phase signal Uₚₕ to a value at which the resonating circuit 7 is resonantly excited. The control algorithm used here by the control unit can be freely selected and for example may be a proportional controller. The control algorithm may be stored in a memory 32 of the control unit 31.

A simple possibility for a controller lies in always changing the frequency of the control signal U_{d} by a constant value when the length of the voltage pulses of the phase signal Uₚₕ deviates from the target value. When the frequency of the control signal U_{d} is smaller than the resonance frequency of the resonating circuit 7, as is illustrated in the case of FIG. 4, the frequency of the control signal U_{d} is thus increased by the constant value. When the frequency of the control signal U_{d} is greater than the resonance frequency of the resonating circuit 7, as is illustrated in the case of FIG. 5, the frequency of the control signal U_{d} is then reduced by the constant value.

Instead of starting the pulses of the phase signal Uₚₕ with a rising flank of the control signal U_{d} and ending same with a rising zero crossing of the current Iᵢ flowing in the resonating circuit 7, the pulses of the phase signal Uₚₕ can also be started for example with a falling flank of the control signal U_{d} and ended with a falling zero crossing of the current Iᵢ flowing in the resonating circuit 7. Another possibility lies in starting the pulses of the phase signal Uₚₕ with a rising zero crossing of the current Iᵢ flowing in the resonating circuit 7 and ending same with a rising flank of the control signal U_{d}. It is equally possible to start the pulses of the phase signal Uₚₕ with a falling zero crossing of the current Iᵢ flowing in the resonating circuit 7 and to end same with a falling flank of the control signal U_{d}.

The target value to which the control unit 31 controls the phase offset is changed during running operation of the corona ignition device depending on the electrical power. To fix the target value, a characteristic curve stored in a memory of the control unit 31 can be used here. The power to be fed into the resonating circuit 7 and thus the power converted by the corona discharge is typically predefined by an engine control device depending on engine operating parameters. Alternatively or additionally to the power, the target value can also be changed depending on other operating parameters, for example the temperature.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

1. A method for controlling a corona ignition device having an ignition electrode at which a corona discharge is produced, a resonating circuit containing the ignition electrode, and a high-frequency generator connected to the resonating circuit, the method comprising:
exciting the resonating circuit with an AC voltage produced by the high-frequency generator, the frequency of said voltage being specified by a control signal applied to the high-frequency generator;
changing the frequency of the control signal as a control variable of a control circuit; and
regulating the phase position between the current flowing in the resonating circuit and a voltage signal to a target value that is changed during the operation of the corona ignition device.

2. The method according to claim 1, wherein the control signal is used as a voltage signal.

3. The method according to claim 1, wherein the controller of the control circuit is a proportional controller.

4. The method according to claim 1, wherein the controller of the control circuit always increases or reduces the frequency of the control signal by a constant value when the phase position between the current flowing in the resonating circuit and the control signal deviates from the target value.

5. The method according to claim 1, wherein the phase position is controlled in the control circuit by producing a square wave signal, of which the value is changed either with a rising zero crossing of the control signal and a rising zero crossing of the current flowing in the resonating circuit or with a falling zero crossing of the control signal and a falling zero crossing of the current flowing in the resonating circuit, and the pulse width of this square wave signal is controlled to a target value.

6. The method according to claim 1, wherein the control signal is a square wave signal.

7. The method according to claim 1, wherein the frequency of the AC voltage matches the frequency of the control signal.

8. The method according to claim 1, wherein the target value is changed as a function of engine operating parameters.

9. The method according to claim 1, wherein the target value is different from zero.

10. A corona ignition device for igniting fuel in a combustion chamber of an internal combustion engine, comprising:
a resonating circuit containing an ignition electrode;
a high-frequency generator connected to the resonating circuit configured to produce an AC voltage in order to excite the resonating circuit; and
a control unit for controlling the high-frequency generator, wherein the control unit is configured to specify the frequency of the AC voltage by a control signal;
wherein the control unit, during operation, is configured to determine the phase position between the current flowing in the resonating circuit and the control signal and controls said phase position to a target value by changing the frequency of the control signal.
